(19) United States
(12) Patent Application Publication
(10) Pub. No.: US 2002/0180356 A1
(43) Pub. Date: Dec. 5, 2002

(54) Sulfur lamp

(76) Inventors: Douglas A. Kirkpatrick, Great Falls, VA (US); Donald A. MacLennan, Gaithersburg, MD (US); Tzvetelina Petrova, Springfield, VA (US); Victor D. Roberts, Burnt Hills, NY (US); Brian P. Turner, Germantown, MD (US)

Correspondence Address: FUSION LIGHTING INC, PAUL E STEINER, 7524 STANDISH PLACE, ROCKVILLE, MD, 20855

(21) Appl. No.: 10/116,748

(22) Filed: Apr. 5, 2002

Related U.S. Application Data
(60) Provisional application No. 60/281,370, filed on Apr. 5, 2001.

(51) Int. Cl. H01J 11/02

(52) U.S. Cl. 313/607

(57) ABSTRACT

An electrodeless discharge lamp includes a pair of opposed couplers aligned along an axis, a stationary light transmissive envelope positioned between the pair of opposed couplers, the envelope having an interior length along the axis which is greater than a maximum interior dimension of the envelope orthogonal to the axis, a light emitting fill disposed inside the envelope, the fill including at least one fill substance selected from the group of sulfur, selenium, and tellurium in a concentration of at least 1 mg/cc for each selected fill substance, and a power source connected to the couplers, wherein power applied to the couplers from the power source is effective to initiate and sustain a stable light emitting discharge from the fill. For example, the envelope may be capsule shaped or have the shape of a prolate ellipsoid. The lamp operates at low power and is stable without rotation.

### RELATED APPLICATIONS

This application is based on and claims priority to U.S. Provisional Application No. 60/281,370, filed Apr. 5, 2001.

Certain inventions described herein were made with Government support under Contract Nos. DE-FC01-97EE23776 and DE-FC26-01 NT41198 awarded by the Department of Energy (DOE). The Government has certain rights in those inventions.

The goal of the DOE's competitive Lighting Research and Development (LR&D) Program is to develop viable technologies having the technical potential to conserve 50% of lighting consumption by 2010. The Program partners with industry, utilities, universities, and research institutions to create energy efficient lighting technologies in pursuit of this goal.

### BACKGROUND

1. Field of the Invention

The invention relates generally to discharge lamps. The invention relates more specifically to a novel sulfur discharge lamp.

1. Related Art

A sulfur discharge providing an efficient source of visible light is described in U.S. Pat. No. 5,404,076, assigned in common with the owner of the present application. Recognized throughout the world as a pioneering discovery in the lighting field, the sulfur lamp's primary applications to date have been limited to large area illumination where the enormous quantity of light generated by the sulfur bulb can be effectively distributed. The sulfur lamps in these applications typically draw over 1000 Watts of wall plug power and produce well in excess of 100,000 lumens from a light bulb about the size of a golf ball. The lamps utilize a magnetron to provide microwave power to the bulb. The lamps also generally utilize active cooling for the bulb, the electronics, or both.

Those skilled in the art further understand that a sulfur fill generally requires rotation of the bulb for stable light output. For example, U.S. Pat. No. 5,990,624 issued to Maya suggests that the sulfur lamp requires rotation. U.S. Pat. No. 6,020,690 issued to Takeda et al. suggests that the sulfur lamp requires rotation.

U.S. Pat. No. 6,016,031 issued to Lapatovich et al. also suggests that the sulfur lamp requires rotation. 5

A few examples of non-rotating sulfur bulbs are mentioned in the patent literature. U.S. Pat. No. 5,903,091 describes a non-rotating sulfur lamp. A reflective ceramic jacket is utilized together with a very low sulfur fill density (e.g. less than 0.5 mg/cc) to achieve stable operation without rotation. Such aperture lamps provide very high brightness light sources. U.S. Pat. No. 5,914,564 describes a bulb having a cylindrical toroid shape which is purported to operate without rotation. The lamp utilizes a central electrode and an outer electrode. It is not clear from the patent whether a stable sulfur discharge without rotation is in fact achieved. Rotation of the electric fields has been suggested as an alternative to rotation of the bulb. PCT Publication No. WO 98/53474 describes a magnetron driven electrodeless lamp which achieves a stable sulfur discharge with a rotating electric field. U.S. Pat. Nos. 5,498,928 and 5,818,167 issued to Lapatovich also describe electrodeless lamps with rotating electric fields. Sulfur is suggested as a suitable fill material in the '928 and '167 patents, although no working examples are given.

Capsule shaped bulbs are well known in the art. U.S. Pat. No. Nos. 5,889,368, 6,016,031, and 6,107,752 all describe electrodeless lamps with capsule shaped bulbs. However, none of these patents suggest that sulfur would be a suitable fill material for a capsule shaped bulb. In fact, the '031 patent teaches away from the use of sulfur fills in capsule shapes bulbs and specifically identifies several purported disadvantages to sulfur lamps including the need for forced air cooling and rotation.

A non-rotating, low power sulfur lamp has numerous commercial applications and has the potential to provide significant energy savings. Significant research and development work has been devoted to developing lower power sulfur lamps with efficient light output that may be operated without rotation and energized by solid state circuitry. The United States Department of Energy and other government agencies have funded numerous efforts to develop a low power sulfur lamp. However, most of these lower power lamps have required rotation for stable operation.

What is needed, and what has long been desired by the lighting community, is a low power, non-actively cooled, non-rotating sulfur lamp, preferably energized by solid state electronics.

### SUMMARY

One object of the invention is to provide a stable, non-rotating sulfur discharge. Another object of the invention is to provide such a discharge at low power (e.g. <200W). Another object of the invention is to provide such a discharge in a non-actively cooled lamp (e.g. convective or radiative cooled). A further object of the invention is to energize such a discharge with solid state electronics.

As used herein, a stable discharge refers to a discharge arc which commutes from near one end of the bulb envelope to near the other end of the bulb envelope and the arc is maintained for a significant period of time without extinguishing and without causing catastrophic bulb failure. In most prior art sulfur lamps which required rotation, in the absence of rotation the arc does not fully form (i.e. only a partial discharge is achieved), the arc may extinguish within a few tens of seconds, and/or catastrophic bulb failure may occur within a few tens of seconds.

The sulfur/selenium/tellurium lamps described herein are not as efficient and may not be as long lived as many of the rotating sulfur lamps described in the patent literature. However, those skilled in the art should appreciate that the stable operation of a low power sulfur lamp without rotation is a significant advance in the state of the art.

One aspect of the present invention is achieved by a wall stabilized capsule shaped lamp enclosing a sulfur fill, wherein the bulb geometry and the sulfur fill density are configured to provide a thermal profile which inhibits the formation of long chain sulfur species during operation. The fill density provides a high pressure sulfur discharge in excess of about 5 atmospheres and preferably in excess of 10 atmospheres.

Another aspect of the present invention is achieved by a wall stabilized capsule shaped lamp enclosing a selenium or tellurium fill, wherein the bulb geometry and the fill density are configured to provide a thermal profile which inhibits the formation of long chain selenium or tellurium species during operation.

The foregoing and other objects, aspects, advantages, and/or features of the invention described herein are achieved individually and in combination. The invention should not be construed as requiring two or more of such features unless expressly recited in a particular claim.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a block diagram of a lamp system in accordance with the present invention.

FIG. 2 is a schematic representation of a lamp system in accordance with the present invention.

FIG. 3 is a schematic representation of a bulb and RF coupling structure.

FIG. 4 is a schematic, partial cross section representation of a bulb and yet another RF coupling structure.

FIG. 5 is a schematic, cross section view of an electrodeless lamp bulb utilized with the present invention.

FIG. 6 is a schematic, front view of an example of a practical lamp coupling structure in accordance with the present invention.

FIG. 7 is a fragmented, cross sectional view of the lamp capsule disposed between the two electrodes of the lamp system from FIG. 6.

FIG. 8 is a schematic, top view of the lamp system from FIG. 6.

FIG. 9 is a perspective view of a lamp system, together with a conductive enclosure.

FIG. 10 is a cross-sectional schematic representation of an alternative bulb shape suitable for use with the present invention.

FIG. 11 is a schematic representation of another lamp system in accordance with the present invention.

FIG. 12 is a schematic representation of another lamp system in accordance with the present invention.

FIG. 13 is a schematic representation of another practical lamp system in accordance with the present invention.

FIG. 14 is a schematic representation of another practical lamp system in accordance with the present invention.

FIG. 15 is a graph of the spectrum of a sulfur discharge from a lamp of the present invention.

FIG. 16 is a graph of the spectrum of a selenium discharge from a lamp of the present invention.

FIG. 17 is a graph of the spectrum of a tellurium discharge from a lamp of the present invention.

FIG. 18 is a graph of the spectrum of a sulfur and selenium discharge from a lamp of the present invention.

FIG. 19 is a circular cross sectional representation of the thermal profile believed to be provided in accordance with the invention.

FIG. 20 is a graphical representation of the thermal profile believed to be provided in accordance with the invention.

FIG. 21 is a lengthwise cross sectional representation of the optical path length in accordance with the invention.

### DESCRIPTION

In the following description, for purposes of explanation and not limitation, specific details are set forth such as particular structures, interfaces, techniques, etc. in order to provide a thorough understanding of the present invention. However, it will be apparent to those skilled in the art having the benefit of the present specification that the invention may be practiced in other embodiments that depart from these specific details. In certain instances, descriptions of well known devices, circuits, and methods are omitted so as not to obscure the description of the present invention with unnecessary detail.

With reference to FIG. 1, an electrodeless discharge lamp 11 includes a pair of opposed couplers 12 and 13 aligned along an axis A. A light transmissive envelope 14 is positioned between the pair of couplers 12, 13. The envelope has an interior length L along the axis A which is substantially greater than any interior dimension D of the envelope 14 orthogonal to the axis A. A light emitting fill is disposed inside the envelope 14. The fill includes at least one of sulfur, selenium, and tellurium in a concentration of at least 1 mg/cc. A power source 15 is connected to the couplers 12, 13. Power applied to the couplers 12, 13 from the power source 15 is effective to initiate and sustain a stable light emitting discharge from the fill.

A cross section of the bulb 14 taken along line C-C (perpendicular to the axis A) may have any arbitrary shape, but is preferably in the shape of a circle. Other cross sectional shapes include elliptical, square, rectangular, triangular, other geometrical shapes, or arbitrarily shaped. The dimension D and the cross sectional shape may vary at different points along the axis A. The interior length L of the bulb 14 is substantially greater than the greatest interior dimension D orthogonal to the axis A. For example, if the cross sectional shape is circular, the dimension D corresponds to the diameter. Generally the aspect ratio of length L to the dimension D (L:D) is 2:1 or more and preferably is 3:1 or more. For example, for a maximum inside diameter of 2 mm, the inside length is at least 4 mm and preferably 6 mm or more.

Although with respect to the drawing, the bulb 14 appears in a horizontal discharge position, the bulb 14 and the discharge may be operated in other orientations.

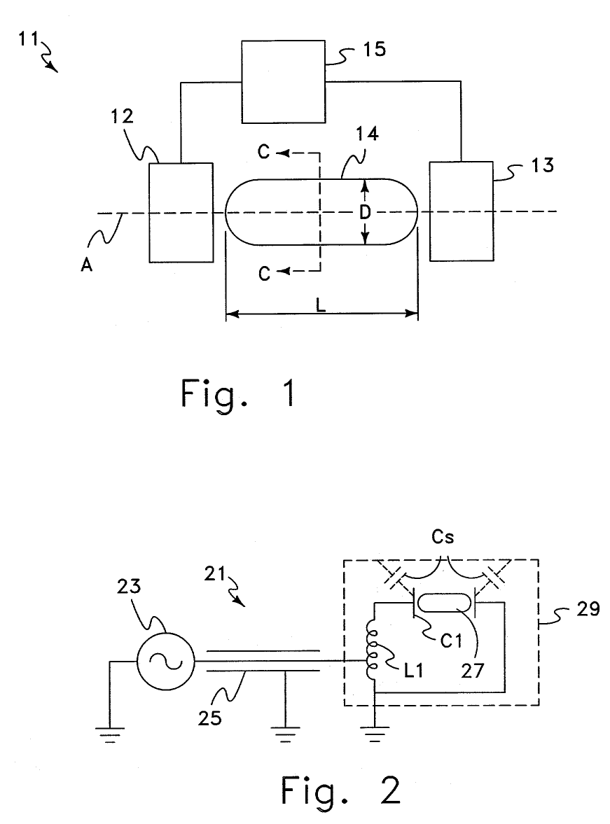

With reference to FIG. 2, an electrodeless discharge lamp 21 includes a series resonant LC lamp circuit comprising an inductor L1 connected in series with a capacitor C1. The respective other ends of the inductor L1 and the capacitor C1 are RF grounded. RF power is provided to the resonant lamp circuit by an RF source 23 via a transmission line 25. The transmission line 25 is connected to a tap on the inductor L1, effectively forming an auto-transformer. An electrodeless lamp bulb 27 is positioned between the plates of the capacitor C1. An electrically grounded enclosure 29 is positioned around the resonant lamp circuit, including the bulb 27. Stray capacitances C_{S} are formed between the resonant lamp circuit and the enclosure 29.

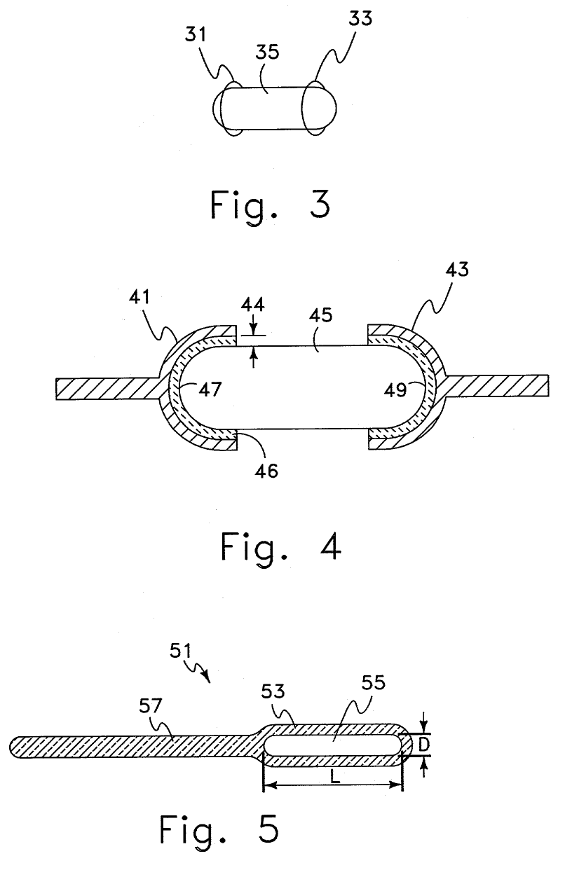

With reference to FIG. 3, an RF coupling structure includes a pair of external ring electrodes 31 and 33. An electrodeless lamp bulb 35 is positioned between the electrodes 31 and 33. In FIG. 3, the electrodes are positioned inward of the ends of the bulbs so that the fields are concentrated inward from the ends of the bulb 35. In operation, RF power is applied to one ring (e.g. ring 31) and the other ring (e.g. ring 33) is RF grounded. With a suitable fill material and voltage applied across the electrodes, a discharge is formed between the two electrodes. For example, the ring electrodes 31 and 33 are a pair of conductive rings (e.g. metal rings) positioned inward of the ends of an electrodeless lamp bulb 35.

With reference to FIG. 4, a preferred RF coupling structure includes a pair of bowl shaped external electrodes 41 and 43, with an electrodeless lamp bulb 45 having respective ends 47 and 49 positioned inside of the concave portion of the electrodes 41 and 43. In operation, the fields are concentrated in between the openings of the electrodes 41 and 43, spaced inward of the absolute ends 47 and 49 of the bulb 45.

A gap 44 may be present between the bulb 45 and the electrodes 41 and 43. The gap 44 may be air or may optionally include a dielectric material 46 between the bulb 45 and the electrodes 41 and 43. The dielectric 46 is selected to provide desired electrical and I or thermal characteristics. For example, quartz wool may be disposed between the bulb and the electrodes for thermal management of the bulb temperature at the ends of the bulb 45.

Operational Lamp Example

With reference to FIG. 5, a preferred geometry for an electrodeless lamp bulb 51 is referred to as a capsule shaped bulb because the bulb 51 has the general shape of a tube with a thin bore. The capsule shaped bulbs used with the present invention have a length L in one dimension which is greater than the diameter D perpendicular to the lengthwise axis. The lamp bulb 51 includes a light transmissive envelope 53 which defines a sealed volume 55 containing a fill material which forms a light emitting plasma when excited, for example, by RF energy. The bulb 51 further includes an optional stem 57 which may be used to support the envelope 53 in a desired position. The stem 57 may be attached to the envelope 53 at any suitable location on the envelope 53 for providing the desired mechanical support.

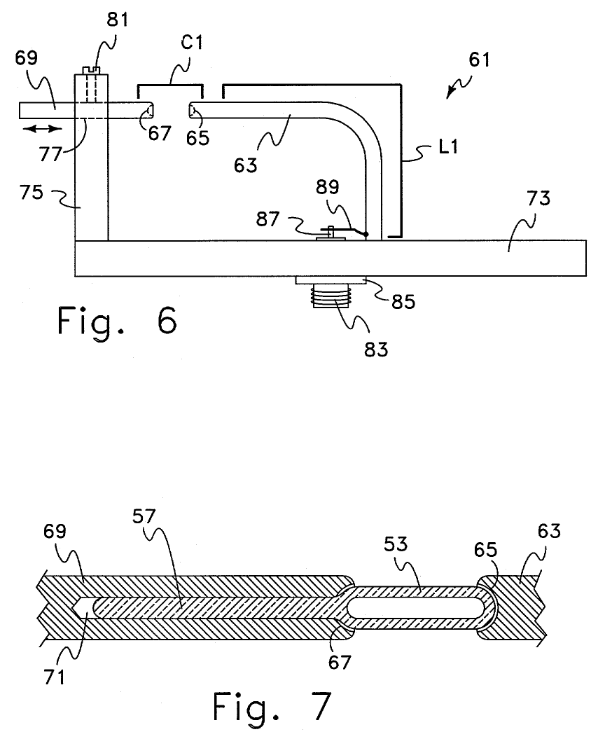

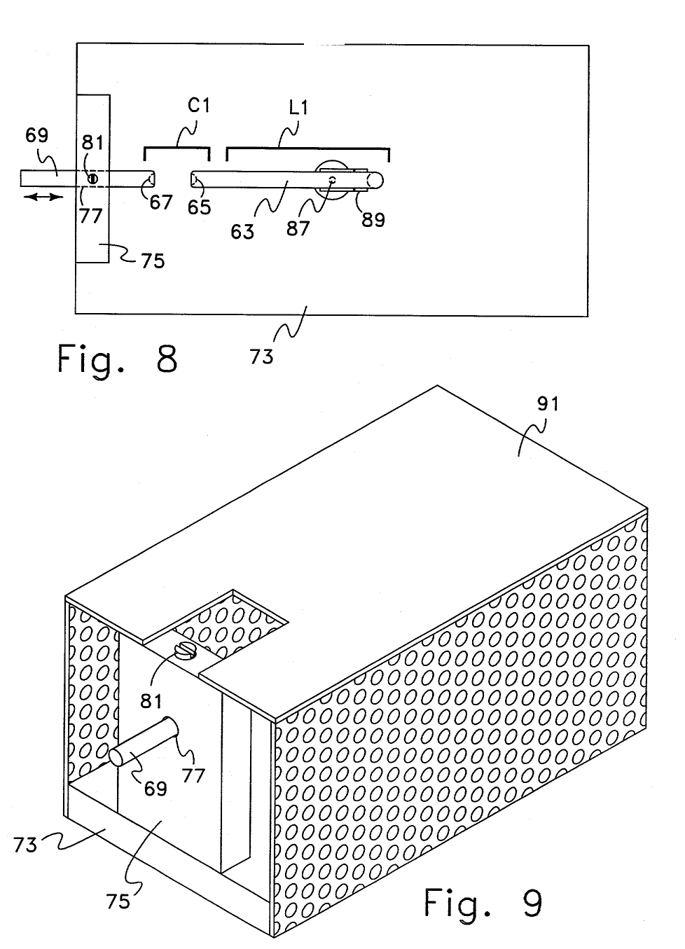

With reference to FIGS. 6-9, an RF coupling structure 61 for transferring RF energy to a fill in a discharge lamp includes a series resonant LC lamp circuit made from an inductor L1 and a capacitor C1. The inductor L1 is formed from a copper rod 63 having a length selected to provide a desired inductance at the resonant frequency. In the illustrated example, the rod 63 is turned at a 90° angle over a small radius. The capacitor C1 has two spaced apart electrodes 65 and 67. The first electrode 65 is formed integral with the rod 63. The second electrode 67 is formed in a second copper rod 69. The electrodes 65 and 67 defined opposed bowl shaped openings. Preferably, the ends of the electrodes 65 and 57 are electro-polished to remove burrs. The second rod 69 further defines a bore 71 adapted to receive the stem 57 and support the envelope 53 in a desired position. If desirable, the bore 71 may have a somewhat larger diameter near the electrode 67 to reduce the amount of heat transferred from the envelope 53 to the rod 69. The envelope 53 is captured between the electrodes 65 and 67 with the stem 57 in the bore 71 and is positioned such that the ends of the envelope 53 are inside the bowl shaped electrodes 65 and 67, preferably without any portion of the outer wall of the envelope 53 coming in intimate thermal contact with the inside surface of the electrodes 65 and 67.

The first rod 63 is mounted on a conductive base 73 and is electrically and mechanically secured to the base at one end, for example, by soldering, welding, brazing, or other suitable means. In operation, the base 73 is electrically and RF grounded. A conductive support 75 is mounted on the base 73 and defines a hole 77 which is axially aligned with the electrode 65. For example, the base 73 and the support 75 may be made from aluminum. The second rod 69 is positioned through the hole 77 and the position of the rod 69 may be adjusted to accommodate different lengths of capsule shaped lamp bulbs. A set screw 81 may be used to hold the rod 69 in position and to ensure a good ground contact with the support 75. Those skilled in the art will appreciate that portions of the rod 69, the base 73, and the support 75 also contribute to the inductance L1.

A coaxial connector 83 is mounted on the base 73 on a side of the base opposite of the rod 63. The outer conductor 85 is mechanically and electrically connected to the base 73. The inner conductor 87 extends through the base 73 to the same side as the rod 63. An conductive element 89 connects the inner conductor 87 to the rod 63, forming an impedance matching system. For example, the element 89 is a flat copper ribbon slightly wider than the rod 63 and bent to contact the rod 63 at some point above the base 73. The element 89 is soldered at one end to the inner conductor 87 and at the other end to the rod 63 at the contact point. In many cases, the impedance matching system is adapted to couple to a 50 Ohm transmission line (e.g. a standard coaxial cable). The point of contact where the element 89 taps the inductor L1 may be adjusted to change the amount of voltage applied across the electrodes 65 and 67. In general, moving the contact position closer to the base 73 provides more voltage and changes the RF match.

An RF grounded conductive enclosure 91 is positioned around the inductor L1 and capacitor C1. The enclosure 91 is spaced from the LC lamp circuit, but is close enough to provide stray capacitances between the electrodes 65, 67 and the enclosure 91. The stray capacitances contribute to the resonant circuit and matching with the RF source. The enclosure 91 further acts to contain the fields applied to the bulb 51.

Any suitable source of RF energy may be coupled to the lamp via the connector 83. For example, the lamp may be energized with a Kalmus™ linear RF amplifier, having a maximum power of 300W in the frequency range of 500 MHz-1 GHz. Other suitable sources are found in PCT Publication Nos. WO 99/36940 and WO 01/03161, which describe various efficient solid state RF sources having power outputs in the range of tens of watts to hundreds of watts and frequencies in the range of 400 MHz to about 1 GHz. Another suitable efficient solid state RF source is described in PCT Publication No. WO 02/23711.

Capsule shaped lamps may be constructed having an inner diameter of 2 mm, an outer diameter of 4 mm, and an internal sealed volume length ranging from 5 mm to 25 mm. For example, the corresponding internal volume ranges from about 0.02 to about 0.1 cubic centimeters; the surface area ranges from about 1.0 to about 3.0 square centimeters; and the lamp is dosed with between 0.5 and 3 mg of sulfur, having a fill density of at least 1 mg/cc and preferably ranging from 10 to 100 mg/cc. The lamp fill also generally includes an inert gas and a small amount of Kr₈₅ for starting.

One practical example of a low power density, high pressure sulfur discharge lamp which is stable without rotation is constructed as follows. The capsule shaped bulb has the general configuration as shown in FIG. 5, with a 2 mm inner diameter, a 4 mm outer diameter, and a 14 mm internal sealed volume length. The internal volume is about 0.04 cubic centimeters and has an envelope outer surface area of about 2.0 square centimeters. The lamp is dosed with about 1.0 mg of sulfur, corresponding to a fill density of about 25 mg/cc. The fill further includes 25 Torr krypton and a small amount of Kr₈₅.

The first and second copper rods have a diameter of about 6.3 mm. One end of each rod is drilled with a 4.5 mm hemispherical bit to form the bowl shaped electrode. The edges of the electrode ends of the rods are rounded. The second rod is further drilled with a 2 mm bit to form the bore for receiving the bulb stem. The electrodes are electro-polished to remove burrs. The first rod is about 100 mm long and turned to a right angle with a 26 mm radius so that the top of the first rod is about 48 mm above the base. The second rod is about 60 mm long. The base is made from a 90 mm×165 mm slab of aluminum about 12.8 mm thick. The support is also made from aluminum and is about 46 mm wide, 70 mm high, and 12.8 mm thick. A 6.4 mm hole is drilled through the support so that the top of the second rod is aligned with the first rod about 48 mm above the base.

The center conductor of the coaxial connector is spaced about 15 mm from where the first rod is attached to the base. A thin strip of copper about 8 mm wide is soldered to the center conductor about 3 mm above the base and runs parallel to the base for about 10 mm where it is bent such that a tab connects the first rod about 1 mm above the base. A perforated section of sheet metal is cut about 256 mm long and 165 mm wide and bent at 83 mm in from each end to form the 83×90×165 mm enclosure. The enclosure is attached by screws to the long sides of the base. The short sides of the base are open except for the support on one side. A small section of the enclosure about 25 mm wide by 50 mm long is cut out over the bulb so that the bulb may be more easily observed during operation.

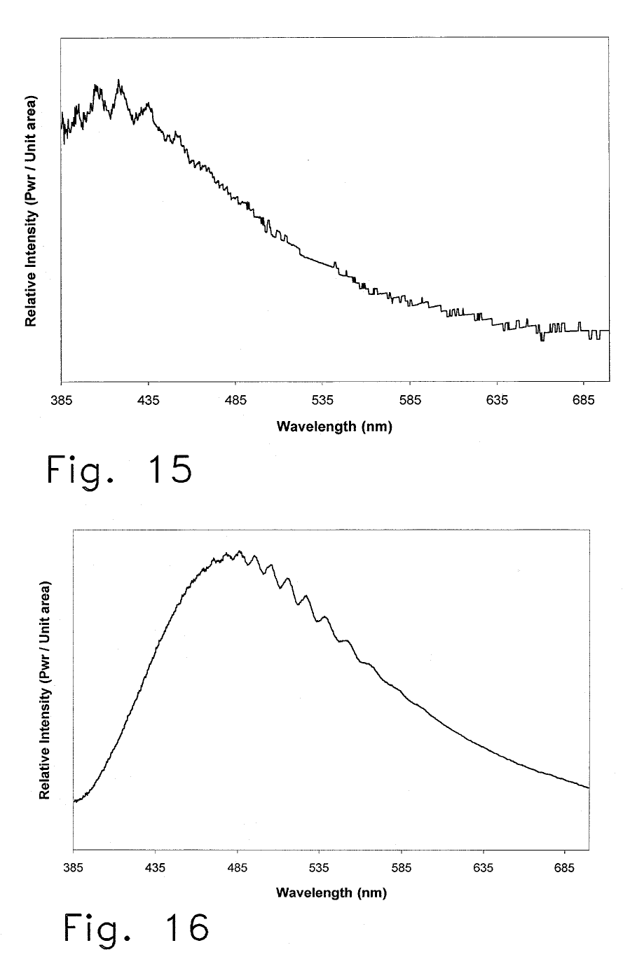

The lamp is powered with between about 40 and 80 W of RF power at a frequency of about 720 MHz from a commercially available Kalmus power amplifier. The wall loading is between 20 and 30 W/cm². The discharge provides a significant amount of visible light and is stable without rotation with no observable sludge (as hereinafter defined). A representative spectrum of the sulfur discharge is shown in FIG. 15.

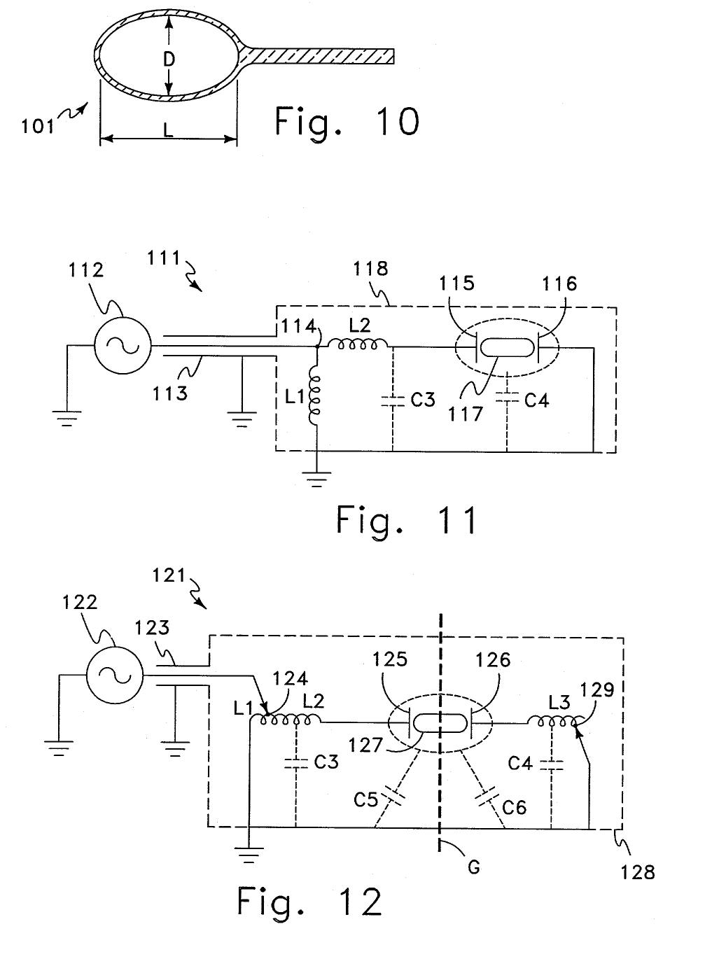

With reference to FIG. 10, an alternative bulb 101 suitable for use with the present invention has the general shape of a prolate ellipsoid. The lengthwise cross section is elliptical while the cross section perpendicular to the lengthwise axis is circular with diameters which vary along the length of the axis. The length L corresponding to the major axis of the elliptical cross section coincides with the lengthwise axis of the bulb 101 and is substantially larger than the largest dimension D perpendicular to the lengthwise axis and corresponding to the minor axis of the elliptical cross section.

With reference to FIG. 11, another lamp system 111 suitable for operating a non-rotating sulfur/selenium/tellurium fill in accordance with the present invention includes a power source 112 and a 50 ohm RF input 113. Power is applied to the lamp circuit at a tap position 114 between two series coils L1 and L2. L1 is RF grounded and L2 is connected to one of a pair of couplers 115 and 116 for capacitively coupling energy to the fill in the bulb 117. The coils L1/L2 and the stray capacitance C3 between the coils and the housing 118 form a series resonant circuit driven by a parallel inductive feed at the tap position 114. There is also a stray capacitance C4 between the bulb 117 and couplers 115,116 and the housing 118. The ratio of L2:L1 (at the tap position) determines the match which in turn is a function of lamp impedance.

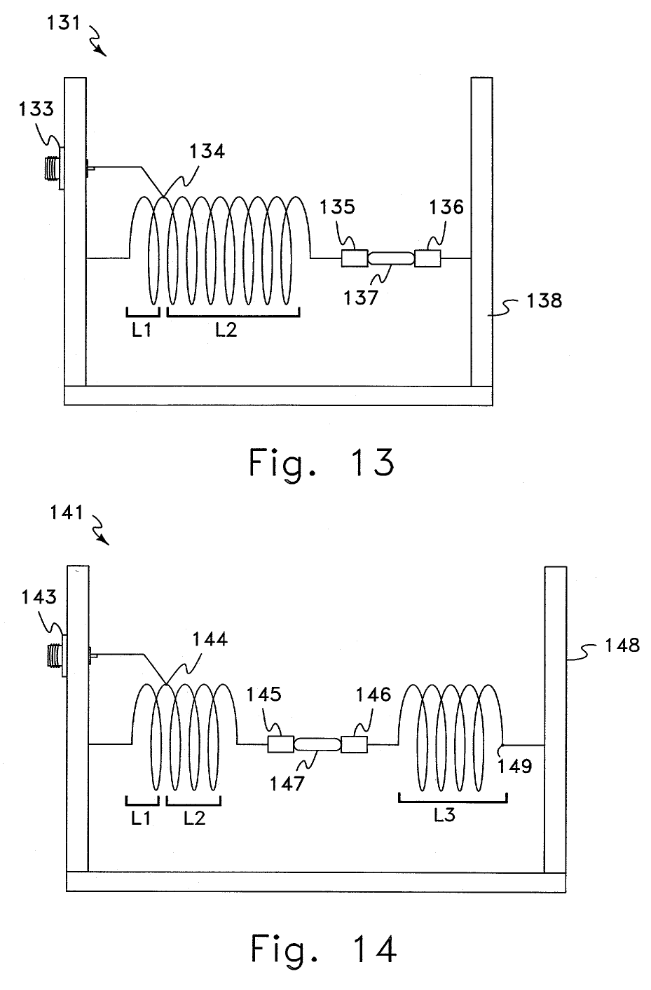

With reference to FIG. 12, another lamp system 121 suitable for operating a non-rotating sulfur/selenium/tellurium fill in accordance with the present invention includes a power source 122 and a 50 ohm RF input 123. Power is applied to the lamp circuit at a tap position 124 between two series coils L1 and L2. L1 is RF grounded and L2 is connected to one coupler 126 of a pair of couplers 125 and 126 for capacitively coupling energy to the fill in the bulb 127. The other coupler 126 is attached to a coil L3 which is connected to ground at a ground tap position 129. With the split coil arrangement shown in FIG. 12, the ground tap position 129 may be adjusted to provide a ground plane G which is fairly precisely centered on the bulb and perpendicular to the lengthwise axis of the bulb 127. The centered ground plane G splits the stray capacitances C5 and C6 thereby reducing the amount of undesirable coupling between the bulb 127 and couplers 125, 126 and the housing 128.

With reference to FIG. 13, an example of how the lamp circuit shown in FIG. 11 may be constructed is as follows. An electrodeless discharge lamp system 131 includes a coaxial connector 133 mounted on a housing 138. A coil L1/L2 is positioned inside the housing 138 with one end connected to ground at the housing 138 and the other end connected to one coupler 135 of a pair of couplers 135, 136. The other coupler 136 is connected to and supported by the housing 138. The coil L1/L2 may be supported within the housing 138 using dielectric blocks. A bulb 137 is positioned between the pair of couplers 135, 136. An electrical connection is made between the center conductor of the connector 133 and the coil L1/L2 at a desired tap position 134.

A practical lamp system 131 is constructed as follows. A conductive enclosure has interior dimensions of approximately 100 mm by 100 mm by 800 mm with conductive walls on all sides. The end walls are 100 mm by 100 mm. A coil is wound on a dielectric support using 14 A.W.G. wire and having about 25 turns of about 56 mm diameter evenly spaced over a distance of approximately 100 mm. One end of the coil is attached to one of the end walls and approximately centered with respect to the side, top, and bottom walls (i.e. the 100 mm by 800 mm walls). One coupler is electrically connected to and mechanically supported by the other end of the coil and the other coupler is electrically connected to and mechanically support by the opposite end wall. The walls of the enclosure are grounded. A coaxial connector is attached to the same end wall as the coil with the outer conductor grounded and the center conductor passing through the wall. The center conductor is electrically connected to the coil at a desired tap position (e.g. to the second or third turn of the coil from the end wall).

In general, fewer turns of the coil are necessary for higher frequencies of operation. Practical lamp systems have been constructed for operation at frequencies ranging from 17 MHz to 750 MHz. The spacing between coil turns is generally as large as practical to reduce interturn capacitance, with a corresponding improvement in efficiency. Also, the distance between the coil and the top, bottom, and side walls is as large as practical up to about one coil diameter on all sides.

With reference to FIG. 14, an example of how the lamp circuit shown in FIG. 12 may be constructed is as follows. An electrodeless discharge lamp system 141 includes a coaxial connector 143 mounted on a housing 148. A first coil L1/L2 is positioned inside the housing 148 with one end connected to ground at the housing 148 and the other end connected to one coupler 145 of a pair of couplers 145, 146. The other coupler 146 is connected to and supported by a second coil L3 connected between the coupler 146 and the housing 148. The coils L1/L2 and L3 may be supported within the housing 148 using dielectric blocks. A bulb 147 is positioned between the pair of couplers 145, 146. An electrical connection is made between the center conductor of the connector 143 and the first coil L1/L2 at a desired tap position 144. An electrical connection is provided between the coil L3 and the housing 148 at a ground tap position 149. If necessary, the ground tap 149 may be adjusted to another position on the coil 43 as needed to provide a ground plane centered on the bulb 147, as may be determined by routine measurements.

A practical lamp system 141 is constructed more or less as described above with respect to the practical lamp system 131, except that the coil is split about in half with the bulb and couplers approximately centered in between the two coil halves.

FIG. 15 shows a representative graph of the spectrum of a low power non-rotating sulfur lamp. The bulb has the dimensions of 4 mm inner diameter, 6 mm outer diameter, and 15 mm internal bulb length. The bulb is dosed with 1.5 mg of sulfur, 25 Torr of krypton, and a small amount of Kr₈₅. The bulb is configured in a discharge lamp system such as the one shown in FIG. 6. The bulb is excited with about 50 watts of RF power at a frequency of 730 MHz. Stable operation of the sulfur discharge is achieved with a high density of fill material, no ceramic jacket, and without rotation of either the bulb or the electric field.

FIG. 16 shows a representative graph of the spectrum of a low power non-rotating selenium lamp. The bulb has the dimensions of 3 mm inner diameter, 5 mm outer diameter, and 16 mm internal bulb length. The bulb is dosed with 3 mg of selenium, 100 Torr of xenon, and a small amount of Kr₈₅. The bulb is configured in a discharge lamp system such as the one shown in FIG. 6. The bulb is excited with about 70 watts of RF power at a frequency of 700 MHz. Stable operation of the selenium discharge is achieved with a high density of fill material, no ceramic jacket, and without rotation of either the bulb or the electric field.

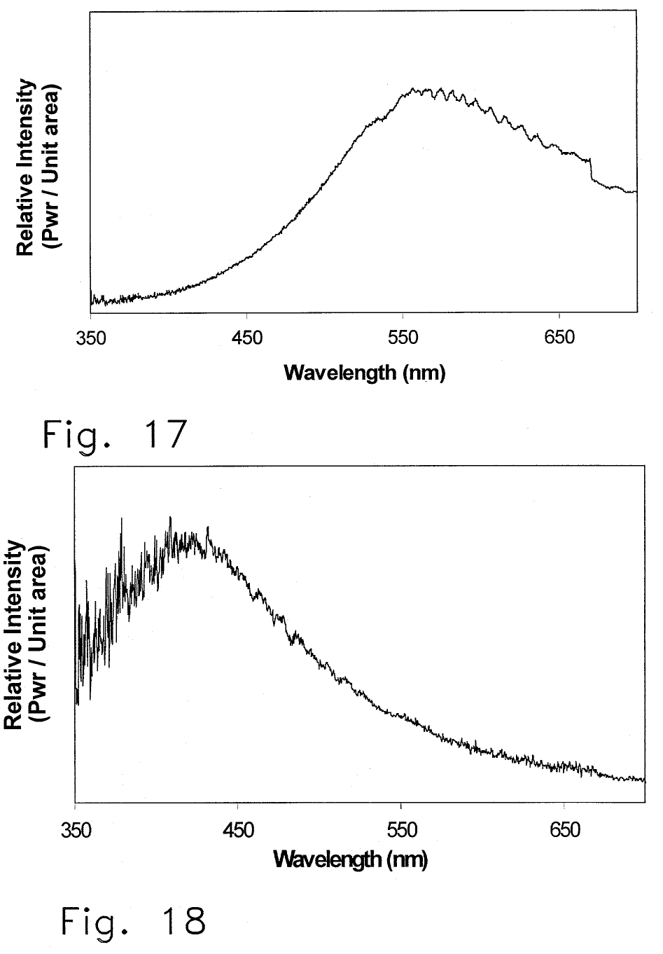

FIG. 17 shows a representative graph of the spectrum of a low power non-rotating tellurium lamp. The bulb has the dimension of 3 mm inner diameter, 5 mm outer diameter, and 16 mm internal bulb length. The bulb is dosed with 0.1 mg of tellurium, 100 Torr of xenon, and a small amount of Kr₈₅. The bulb is configured in a discharge lamp system such as the one shown in FIG. 14. The bulb is excited with about 45 watts of RF power at a frequency of 23 MHz. Stable operation of the tellurium discharge is achieved with a high density of fill material, no ceramic jacket, and without rotation of either the bulb or the electric field.

FIG. 18 shows a representative graph of the spectrum of a low power non-rotating sulfur and selenium lamp. The bulb has the dimension of 2 mm inner diameter, 6 mm outer diameter, and 16 mm internal bulb length. The bulb is dosed with 1 mg sulfur and 1 mg of selenium, 100 Torr of xenon, and a small amount of Kr₈₅. The bulb is configured in a discharge lamp system such as the one shown in FIG. 14. The bulb is excited with about 40 watts of RF power at a frequency of 23 MHz. Stable operation of the discharge is achieved with a high density of fill material, no ceramic jacket, and without rotation of either the bulb or the electric field.

Other examples of bulbs and fills which exhibit stable operation include the following:

TABLE I

| Dimensions (A) | Fill | Input Power | Frequency |
|---|---|---|---|
| 3 × 5 × 16 | 3 mg S; 600 Torr Xe | 50 W | 730 MHz |
| 3 × 5 × 16 | 3 mg S; 600 Torr Xe | 50 W | 419 MHz |
| 3 × 5 × 16 | 2 mg Se; 100 Torr Xe | 50-60 W | 708 MHz |
| 3 × 5 × 8 | 2 mg Se; 100 Torr Xe | 40 W | 671 MHz |
| 2 × 6 × 16 | 1 mg Se; 100 Torr Xe | 30 W | 34 MHz |
| 2 × 6 × 16 | 2 mg Se; 100 Torr Xe | 20-70 W | 34 MHz |
| 2 × 6 × 8 | 0.5 mg Se; 100 Torr Xe | 40 W | 36 MHz |
| 9 × 16 | 7 mg Se; 100 Torr Xe | 50 W | 19 MHz |
| 8 × 12 | 1.8 mg Se; 100 Torr Xe | 30 W | 19 MHz |
| 11 × 14 | 5 mg Se; 100 Torr Xe | 40-60 W | 19 MHz |
| 10 × 12 | 3 mg Se; 100 Torr Xe | 40 W | 17 MHz |
| 8 × 12 | 1 mg Se; 100 Torr Xe | 30 W | 17 MHz |
| 10 × 12 | 0.6 mg Se; 100 Torr Xe | 20-40 W | 17 MHz |
| 3 × 5 × 16 | 0.6 mg S; 100 Torr | 25 W | 720 MHz |
| 3 × 5 × 16 | 0.6 mg Se; 20 Torr Ar | 25 W | 720 MHz |

(A) Where the dimensions in Table 1 are in the form D1×D2×D3, the bulb shape is generally capsule shaped with D1 corresponding to the inner diameter, D2 corresponding to the outer diameter, and D3 corresponding to the internal length (all in mm); where the dimensions are of the form D1×D2, the bulb shape is a prolate ellipsoid with D1 corresponding to the internal minor axis and D2 corresponding to the internal major axis (both in mm).

Principles of Operation

A known problem with the sulfur discharge lamp is the formation of long chain sulfur species in the discharge volume which interfere with efficient light extraction. These long chain species are also referred to herein as sludge. In most known sulfur lamps, the formation of sludge is inhibited by rotating the bulb. Rotation of the bulb causes a mixing of the plasma which in turn causes the long chain species to encounter regimes of temperature and other sulfur species which decompose the long chain sulfur species into S₂. In the lamps described in the '091 patent, the formation of sludge is inhibited by a very low fill density of sulfur material.

While the inventors do not wish to be bound by theories of operation, the following discussion is believed to identify the guiding principles which led to the present invention of a low power density, high fill pressure sulfur discharge lamp which is stable without rotation.

1) Controlling the species of sulfur present in the discharge to avoid long chain species

A) the bulb geometry is adapted to provide a thermal profile which inhibits the formation of sludge;

B) the thermal profile supports low to moderate wall loading and allows non-active (e.g. convective) cooling of the bulb.

2) Stabilizing the Arc

A) the high aspect ratio discharge tube promotes a discharge which is wall stabilized;

B) there is a defined area at respective ends of the bulb where the discharge initiates and terminates;

C) the thermal and electrical load of the arc is distributed both along the arc tube and at the arc termina at the ends of the arc tube.

Bulb Geometry and Sulfur Fill Pressure

Formation of sludge in the discharge is detrimental to stable operation and reduces light output efficiency. With the present invention, a suitable geometry provides convective and radiative power dissipation from the envelope and a high sulfur fill pressure provides a suitable thermal gradient inside the envelope such that the probability for sludge forming is reduced and the volume over which sludge might form is very small. Although some degree of the higher order molecules are likely present in the discharge, the amount present has a negligible effect on the light output. Depending on the temperatures at the ends of the bulb, some sludge might be found at the ends.

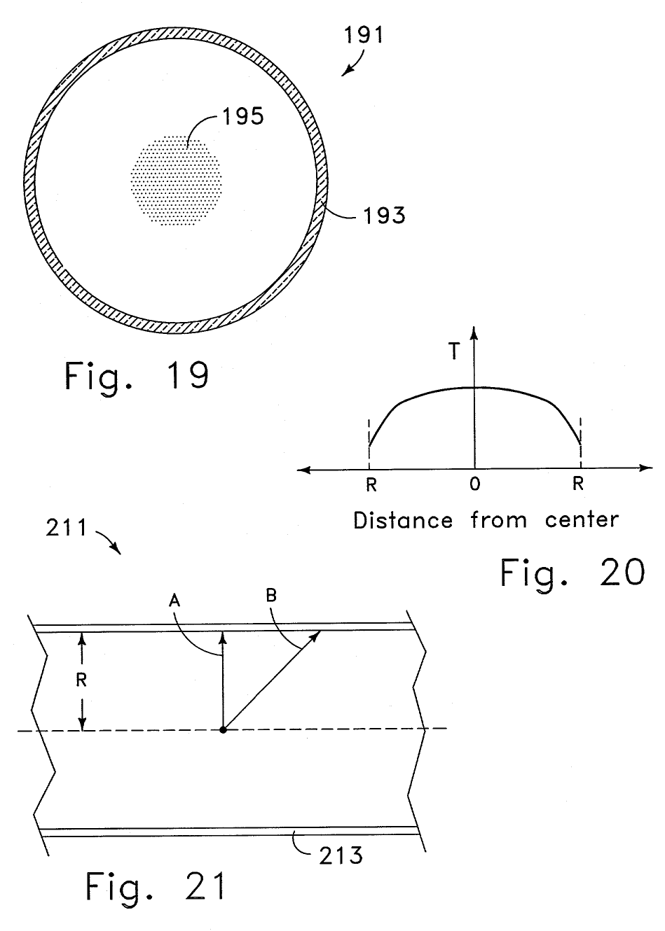

The bulb geometry is aspherical and preferably long and narrow with a circular cross section perpendicular to the length wise axis, although the radius is not necessarily constant along the length. For example, the bulb may be cylindrical or a prolate ellipsoid. With reference to FIGS. 19 and 20, a bulb 191 is configured with its wall 193 spaced relatively close to the hotter plasma core region 195 (e.g. less than a few mm). A relatively steep temperature gradient occurs from the center of the bulb 191 to the wall 193 of the bulb 191, as represented in FIG. 19. FIG. 20 shows a representative temperature profile in graph form. The temperature gradient is believed to support the following conditions: A) with an appropriate fill density the optical path length provides visible light by virtue of absorption and re-emission; and B) the region over which sludge could form is small enough and close enough to the hotter core region 195 that the sludge is broken up or the density of the sludge is so low as to be non-interfering as far as the light output is concerned.

If necessary or desirable, the bulb may be shaped (e.g. a banana shaped bulb), buffer gases may be added to improve uniformity, or acoustic modulation may be used to straighten the arc.

Preferably, the bulb is sized to support convective and radiative cooling to ensure proper bulb temperature. For example, convective and radiative cooling of the quartz is in a safety zone of about 5-6 W/cm². Depending on the efficiency of the fill, the bulb size can be adjusted for slightly more or less wall loading (e.g. 15 to 30 W/cm²). For the intended power input, the surface area of the bulb is then selected to provide the desired wall loading.

For a particular diameter cross section, the fill density (and corresponding fill pressure) is selected to provide a desired optical path length. With reference to FIG. 21, for prior sulfur lamps the fill density is determined in accordance with the radius R (ray A in FIG. 21). However, in accordance with the present invention the fill density is selected in accordance with a 450 ray B (+/−5°) or approximately 1.414 times the radius. In particular, the fill density of the present invention is determined such that the perpendicular line from the center (e.g. ray A) is selected to provide an optical path length which produces light at 420 nm and the line at 450 (e.g. ray B) is selected to produce light at 555 nm. With the capsule shaped lamps of the present invention, more of the light, based on solid angle, is integrated at 45 degrees incident on a surface as opposed to ortho-normal. According, to increase the amount of light coming out in the visible the optical path length is selected primarily for the 45° ray B, not the perpendicular ray A.

The voltage and therefore the power are determined based on the length of the lamp. As the pressure is increased, the thermal gradient increases. Given the radius, a voltage drop per unit length may be determined. That drop and corona in air (or operating environment) from the electrodes establishes the maximum length and maximum power that drives this type of lamp. The amount of power supplied should also satisfy the wall loading requirements discussed above. At higher frequencies, corona is reduced and potentially higher power levels may be applied. Depending on the application (e.g. the frequency and power level), it may be further desirable to surround the arc tube and I or couplers with a vacuum sealed outer envelope. Several of the working examples described above wee operated in a vacuum sealed environment.

Arc Stabilization

The lamp is preferably wall stabilized to promote a stable discharge arc. It is believed that point launch and/or point termination should be avoided. Intimate thermal contact between the electrode and the end of the bulb is also generally avoided or the ends are otherwise thermally managed.

Other lamp structures which are believed to have the potential to provide an electrode and wall stabilized discharge include various slow wave structures, the loop applicator described in U.S. Pat. No. 5,130,612, the helical couplers described in U.S. Pat. No. 5,498,928, the coaxial applicator described in connection with FIGS. 7-8 or FIG. 11 of U.S. Pat. No. 6,107,752, and the end cup applicators described in U.S. Pat. No. 5,241,246.

The arc may be further stabilized using known techniques in the art for stabilizing arc lamps with internal electrodes. For example, acoustical modulation may be effective for further stabilizing the arc.

While the invention has been described in connection with what is presently considered to be the preferred embodiments, it is to be understood that the invention is not limited to the disclosed embodiments, but on the contrary, is intended to cover various modifications and equivalent arrangements included within the spirit and scope of the inventions.

What is claimed is:

1. An electrodeless discharge lamp bulb, comprising:
an aspherical light transmissive envelope having a length between respective ends of the envelope along an axis which is greater than a maximum distance between opposed interior surfaces of the envelope perpendicular to the axis; and
a fill material disposed in the envelope including at least of one sulfur, selenium, and tellurium,
wherein the size of the envelope and the amount of the fill material is selected to provide a thermal profile during operation without rotation which inhibits the formation of long chain species.

2. The discharge lamp bulb as recited in claim 1, wherein the fill material includes sulfur and wherein the amount of sulfur is selected to provide a sulfur fill pressure in excess of five atmospheres during operation, thereby providing visible light from molecular radiation.

3. The discharge lamp bulb as recited in claim 2, wherein the amount of sulfur is selected to provide a sulfur fill pressure in excess of ten atmospheres during operation.

4. The discharge lamp bulb as recited in claim 1, wherein the envelope has a capsule shape with the maximum distance between opposed interior surfaces of the envelope perpendicular to the axis being less than 5 mm and the length between respective ends of the envelope along the axis being at least twice the maximum distance between opposed interior surfaces of the envelope perpendicular to the axis.

5. The discharge lamp bulb as recited in claim 1, wherein the envelope has a capsule shape with the maximum distance between opposed interior surfaces of the envelope perpendicular to the axis being less than 4 mm and the length between respective ends of the envelope along the axis being at least three times the maximum distance between opposed interior surfaces of the envelope perpendicular to the axis.

6. The discharge lamp bulb as recited in claim 1, wherein the envelope has a prolate ellipsoid shape with an elliptical cross section along the axis, and wherein the maximum distance between opposed interior surfaces of the envelope perpendicular to the axis corresponds to a minor axis of the elliptical cross section and the length between respective ends of the envelope along the axis corresponds to a major axis of the elliptical cross section.

7. The discharge lamp bulb as recited in claim 1, wherein the amount of the fill material is at least 1 mg/cc for each of the at least of one sulfur, selenium, and tellurium included in the fill material.

8. The discharge lamp bulb as recited in claim 1, wherein the amount of the fill material is at least 10 mg/cc for each of the at least of one sulfur, selenium, and tellurium included in the fill material.

9. The discharge lamp bulb as recited in claim 1, wherein the amount of the fill material is at least 25 mg/cc for each of the at least of one sulfur, selenium, and tellurium included in the fill material.

10. The discharge lamp bulb as recited in claim 1, wherein the envelope has a capsule shape with the maximum distance between opposed interior surfaces of the envelope perpendicular to the axis being less than 5 mm and the length between respective ends of the envelope along the axis being at least twice the maximum distance between opposed interior surfaces of the envelope perpendicular to the axis,
and wherein the amount of the fill material is at least 1 mg/cc for each of the at least of one sulfur, selenium, and tellurium included in the fill material.

11. The discharge lamp bulb as recited in claim 10, wherein the maximum distance is less than 4 mm and the length is at least three times the maximum distance.

12. The discharge lamp as recited in claim 10, wherein the amount of the fill material is at least 10 mg/cc for each of the at least of one sulfur, selenium, and tellurium included in the fill material.

13. The discharge lamp bulb as recited in claim 10, wherein the maximum distance is less than 4 mm and the length is at least three times the maximum distance and wherein the amount of the fill material is at least 10 mg/cc for each of the at least of one sulfur, selenium, and tellurium included in the fill material

14. An electrodeless discharge lamp, comprising:
a pair of opposed couplers aligned along an axis;
a stationary light transmissive envelope positioned between the pair of opposed couplers, the envelope having an interior length along the axis which is greater than a maximum interior dimension of the envelope orthogonal to the axis;
a light emitting fill disposed inside the envelope, the fill including at least one fill substance selected from the group of sulfur, selenium, and tellurium in a concentration of at least 1 mg/cc for each selected fill substance; and
a power source connected to the couplers, wherein power applied to the couplers from the power source is effective to initiate and sustain a stable light emitting discharge from the fill.

15. The discharge lamp as recited in claim 14, wherein the envelope has a capsule shape with the maximum interior dimension orthogonal to the axis being less than 5 mm and the interior length along the axis being at least twice the interior dimension orthogonal to the axis.

16. The discharge lamp as recited in claim 14, wherein the envelope has a capsule shape with the maximum interior dimension orthogonal to the axis being less than 4 mm and the interior length along the axis being at least three times the interior dimension orthogonal to the axis.

17. The discharge lamp as recited in claim 14, wherein the envelope has a prolate ellipsoid shape with an elliptical cross section along the axis, and wherein the maximum interior dimension orthogonal to the axis corresponds to a minor axis of the elliptical cross section and the interior length along the axis corresponds to a major axis of the elliptical cross section.

18. The discharge lamp as recited in claim 14, wherein the concentration for each selected fill substance is at least 10 mg/cc.

19. The discharge lamp as recited in claim 14, wherein the concentration for each selected fill substance is at least 25 mg/cc.

20. The discharge lamp as recited in claim 14, wherein the envelope has a capsule shape with the maximum interior dimension orthogonal to the axis being less than 5 mm and the interior length along the axis being at least twice the interior dimension orthogonal to the axis,
and wherein the concentration for each selected fill substance is at least 10 mg/cc

21. The discharge lamp as recited in claim 20, wherein the maximum interior dimension is less than 4 mm and the length is at least three times the maximum interior dimension.

22. The discharge lamp as recited in claim 14, wherein the pair of opposed couplers comprises at least one ring shaped electrode.

23. The discharge lamp as recited in claim 14, wherein each of the pair of opposed couplers comprises a ring shaped electrode.

24. The discharge lamp as recited in claim 14, wherein the pair of opposed couplers comprises at least one bowl shaped electrode.

25. The discharge lamp as recited in claim 14, wherein each of the pair of opposed couplers comprises a bowl shaped electrode.

26. The discharge lamp as recited in claim 14, wherein the pair of opposed couplers are adapted to initiate and terminate the discharge inward of the absolute ends of the envelope along the axis.

27. An electrodeless discharge lamp, comprising:
a stationary light transmissive envelope;
a pair of opposed couplers aligned along an axis with the envelope positioned between the pair of opposed couplers, the envelope having a capsule shape with an interior length along the axis which is at least twice greater than a maximum interior dimension of the envelope orthogonal to the axis, wherein the pair of opposed couplers are adapted to initiate and terminate a discharge inward of the absolute ends of the envelope along the axis;
a light emitting fill disposed inside the envelope, the fill including at least one fill substance selected from the group of sulfur, selenium, and tellurium in a concentration of at least 1 mg/cc for each selected fill substance; and
a power source connected to the couplers, wherein power applied to the couplers from the power source is effective to initiate and sustain a stable light emitting discharge from the fill.

28. The discharge lamp as recited in claim 27, wherein the maximum interior dimension orthogonal to the axis is less than 5 mm.

29. The discharge lamp as recited in claim 27, wherein the concentration for each selected fill substance is at least 10 mg/cc.

30. The discharge lamp as recited in claim 27, wherein the pair of opposed couplers comprises at least one ring shaped electrode.

31. The discharge lamp as recited in claim 27, wherein each of the pair of opposed couplers comprises a ring shaped electrode.

32. The discharge lamp as recited in claim 27, wherein the pair of opposed couplers comprises at least one bowl shaped electrode.

33. The discharge lamp as recited in claim 27, wherein each of the pair of opposed couplers comprises a bowl shaped electrode.
